(19) United States
(12) Patent Application Publication
(10) Pub. No.: US 2025/0138519 A1
(43) Pub. Date: May 1, 2025

(54) DIAGNOSIS DEVICE, DIAGNOSIS SYSTEM, AND DIAGNOSIS METHOD

(71) Applicant: Panasonic Intellectual Property Management Co., Ltd., Osaka (JP)

(72) Inventors: Tenta KOMATSU, Osaka (JP); Naganori SHIRAKATA, Osaka (JP); Zhiqi LIU, Osaka (JP); Takayuki TSUKIZAWA, Osaka (JP)

(21) Appl. No.: 18/684,108

(22) PCT Filed: Aug. 12, 2022
(86) PCT No.: PCT/JP2022/030809

§ 371 Date: Feb. 15, 2024

(30) Foreign Application Priority Data
Aug. 25, 2021 (JP) 2021-136860

(51) Int. Cl. G05B 23/02

(52) U.S. Cl. CPC G05B 23/024; G05B 23/0272

(57) ABSTRACT

A diagnosis device includes: an obtainer that obtains operation data about equipment; an identifier that identifies a reproduction model using the operation data obtained by the obtainer; a reproduction data generator that generates reproduction data about the equipment based on the reproduction model identified by the identifier; a diagnosis model generator that performs machine learning using the reproduction data generated by the reproduction data generator, to generate a diagnosis model of the equipment; a diagnoser that diagnoses the equipment based on the diagnosis model generated by the diagnosis model generator; and a display that is an example of an outputter for outputting a diagnosis result provided by the diagnoser.

### CROSS-REFERENCE OF RELATED APPLICATIONS

This application is the U.S. National Phase under 35 U.S.C. § 371 of International Patent Application No. PCT/JP2022/030809, filed on Aug. 12, 2022, which in turn claims the benefit of Japanese Patent Application No. 2021-136860, filed on Aug. 25, 2021, the entire disclosures of which applications are incorporated by reference herein.

### TECHNICAL FIELD

The present disclosure relates to a diagnosis device, a diagnosis system, and a diagnosis method.

### BACKGROUND ART

A large number of motors and gears are used in industrial equipment, industrial machinery, industrial robots, power generation equipment, and the like, which perform production in factories. Not only sudden device troubles, but also abnormalities in equipment due to aging or deterioration by abrasion may cause line stoppages, leading to a concern about decreased productivity or occurrence of accidents.

In view of the situation, there is an increasing demand for a diagnosis system that monitors states of these facilities and supports efficient planned maintenance according to the states of the equipment.

Particularly in recent years, machine learning models that have learned sensor data associated with states of equipment are used, so that highly accurate diagnosis is gradually able to be performed which matches operation conditions and characteristics of the equipment.

Patent Literature (PTL) 1 discloses an abnormality detection system and an abnormality detection method, in which when data required for equipment abnormality is insufficient for verifying an identification model that has learned the state of equipment, abnormality simulation data is generated and the generated abnormality simulation data is used for the verification.

### CITATION LIST

### Patent Literature

[PTL 1]
Japanese Unexamined Patent Application Publication No. 2019-133212

### SUMMARY OF INVENTION

### Technical Problem

However, PTL 1 merely discloses determination on the suitability of the generated identification model by the verification using the abnormality simulation data, and in PTL 1 a suitable identification model may not be generated. Unless the suitable identification model can be generated, equipment cannot be diagnosed with high accuracy.

In view of the above, the present disclosure provides a diagnosis device, a diagnosis system, and a diagnosis method, in which equipment can be diagnosed with high accuracy.

### Solution to Problem

A diagnosis device according to an aspect of the present disclosure includes: an obtainer that obtains operation data about equipment; an identifier that identifies a reproduction model using the operation data obtained by the obtainer; a data generator that generates reproduction data about the equipment based on the reproduction model identified by the identifier; a model generator that performs machine learning using the reproduction data generated by the data generator, to generate a diagnosis model of the equipment; a diagnoser that diagnoses the equipment based on the diagnosis model generated by the model generator; and an outputter that outputs a diagnosis result provided by the diagnoser.

A diagnosis system according to an aspect of the present disclosure includes: the diagnosis device according to the above-described aspect; and the equipment.

A diagnosis method according to an aspect of the present disclosure includes: obtaining operation data about equipment; identifying a reproduction model using the operation data obtained; generating reproduction data about the equipment based on the reproduction model identified; performing machine learning using the reproduction data generated, to generate a diagnosis model of the equipment; diagnosing the equipment based on the diagnosis model generated; and outputting a diagnosis result.

It should be noted that these comprehensive or specific aspects may be embodied by a system, a method, an integrated circuit, a computer program, or a recording medium, and may be embodied by any combination of the system, a device, the method, the integrated circuit, the computer program, and the recording medium.

### Advantageous Effects of Invention

According to the present disclosure, diagnosis on equipment can be performed with high accuracy.

### BRIEF DESCRIPTION OF DRAWINGS

FIG. 1 is a block diagram illustrating an example of a configuration of a diagnosis system according to an embodiment of the present disclosure.

FIG. 2 is a flowchart illustrating an example of a diagnosis method according to the embodiment of the present disclosure.

FIG. 3A is a diagram illustrating an example of a reproduction model with the lowest level of detail according to the embodiment of the present disclosure.

FIG. 3B is a diagram illustrating an example of a reproduction model with the second lowest level of detail according to the embodiment of the present disclosure.

FIG. 3C is a diagram illustrating an example of a reproduction model with the second highest level of detail according to the embodiment of the present disclosure.

FIG. 3D is a diagram illustrating an example of a reproduction model with the highest level of detail according to the embodiment of the present disclosure.

FIG. 4 is a diagram illustrating an example of an input screen displayed on a display according to the embodiment of the present disclosure.

FIG. 5 is a graph illustrating relationship between accuracy of generated reproduction data and the number of identification steps, according to the embodiment of the present disclosure.

FIG. 6A is a diagram illustrating an example of normal-time reproduction data that is training data to be learned by a diagnosis model generator according to the embodiment of the present disclosure.

FIG. 6B is a diagram illustrating an example of failure-time reproduction data that is the training data to be learned by the diagnosis model generator according to the embodiment of the present disclosure.

FIG. 6C is a diagram illustrating an example of operation data that is the training data to be learned by the diagnosis model generator according to the embodiment of the present disclosure.

FIG. 6D is a diagram illustrating an example of machine learning to be performed by the diagnosis model generator according to the embodiment of the present disclosure.

FIG. 7 is a diagram illustrating an example of a diagnosis result displayed on the display according to the embodiment of the present disclosure.

### DESCRIPTION OF EMBODIMENTS

### Summary of the Present Disclosure

The present inventors found that the following problems occur with the conventional abnormality detection system described in the “Background Art” section.

In the abnormality detection system disclosed in PTL 1, data at a time when equipment is operating normally (i.e., operation data during a normal time) is only learned upon generation of an identification model. Accordingly, the anomaly detection system only diagnoses whether the equipment is abnormal or normal, and cannot diagnose what kind of abnormality is occurring and an extent of the abnormality.

In contrast, a diagnosis device according to an aspect of the present disclosure includes: an obtainer that obtains operation data about equipment; an identifier that identifies a reproduction model using the operation data obtained by the obtainer; a data generator that generates reproduction data about the equipment based on the reproduction model identified by the identifier; a model generator that performs machine learning using the reproduction data generated by the data generator, to generate a diagnosis model of the equipment; a diagnoser that diagnoses the equipment based on the diagnosis model generated by the model generator; and an outputter that outputs a diagnosis result provided by the diagnoser.

With this configuration, the machine learning is performed using the reproduction data. Accordingly, a highly accurate diagnosis model can be generated, even when the operation data is insufficient. Since a highly accurate diagnosis model is created, it is possible to detect depth of the failure and a location where the failure occurred. As described above, in the diagnosis device according to the present disclosure, equipment can be diagnosed with high accuracy. It should be noted that improving the accuracy in diagnosis does not only mean that the accuracy in determination of the presence or absence of a failure enhances, but also that specific diagnosis, such as the depth of the failure and/or the location where the failure occurs can be achieved.

Furthermore, in PTL 1, physical simulation is disclosed as a method of generating abnormality simulation data. However, failures in equipment are generally caused by spatially asymmetric structures such as eccentricity of a rotating shaft and partial loss of a gear. Therefore, in order to reproduce the characteristics of a signal caused by a failure, it is necessary to use a detailed simulation model such as a three-dimensional finite element method (FEM) model.

In contrast, in the diagnosis device according to an aspect of the present disclosure, the data generator may generate the reproduction data based on the reproduction model that is selected from a plurality of reproduction models each having a different total number of parameters and is identified by the identifier.

With this configuration, it is possible to use a reproduction model according to a request. For example, when it is desired to generate reproduction data in a short period of time, the reproduction model with a small number of parameters may be selected, thereby generating the reproduction data in a short period of time. In addition, when it is desired to generate the reproduction data with high reproducibility, for example, a reproduction model with a large number of parameters may be selected, thereby generating reproduction data with the high reproducibility.

A detailed simulation model requires a long analysis time and a large number of parameters. Accordingly, a large amount of computational resources is required to accurately identify parameters that reflect the operation conditions and characteristics of the equipment to be diagnosed.

In contrast, in the diagnosis device according to an aspect of the present disclosure, the plurality of reproduction models may include a first reproduction model and a second reproduction model having a total number of parameters larger than a total number of parameters of the first reproduction model, and the data generator may include a parameter converter that converts a parameter of the first reproduction model identified by the identifier, to generate a parameter of the second reproduction model.

With this configuration, it is possible to identify a reproduction model with a large number of parameters by using the identification result of the reproduction model with a small number of parameters. Accordingly, the reproduction model with a large number of parameters can be identified in a short period of time and/or with high accuracy.

For example, the data generator may generate normal-time reproduction data about the equipment, and the identifier may repeatedly update a parameter of the reproduction model using the normal-time reproduction data generated by the data generator, to identify the reproduction model.

With this configuration, the accuracy of the reproduction model can be enhanced, so that the reproduction data with high reproducibility can be generated.

Furthermore, even if the characteristics of a signal at the time of a failure are reproduced through a detailed simulation, conditions not assumed during the simulation may act as noise in an actual operation site, and the reproduced characteristics may be buried in the noise. Accordingly, even if learning is performed with directly using the abnormality simulation data generated by the method disclosed in PTL 1 as the learning data, a diagnosis model that has a high function to diagnose a type and degree of the abnormality in the equipment cannot be generated.

In contrast, in the diagnosis device according to an aspect of the present disclosure, the data generator may generate failure-time reproduction data about the equipment, and the model generator may perform the machine learning using the failure-time reproduction data generated by the data generator.

With this configuration, the reproduction data at the time of failure can be used in place of operation data at the time of failure, which is often lacking, so that the accuracy of the diagnosis model generated by the machine learning can be improved.

For example, the data generator may further generate normal-time reproduction data about the equipment, and the model generator may perform the machine learning further using the normal-time reproduction data generated by the data generator.

With this configuration, the reproduction data at the normal time is further used, so that the accuracy of the diagnosis model generated by the machine learning can be further improved.

For example, the model generator may perform the machine learning further using the operation data obtained by the obtainer.

With this configuration, the actual operation data is used in place of data that cannot be completely reproduced by the reproduction models. Accordingly, the accuracy of diagnosis models generated by the machine learning can be further improved.

For example, the outputter may include a display that displays the diagnosis result.

With this configuration, the diagnosis results can be presented in an easy-to-understand manner to a user including a manager or an operator of the equipment, or a user of the diagnosis device.

For example, the outputter may further output first accuracy information that indicates a degree of accuracy of the diagnosis model.

With this configuration, it is possible to assist a user in determining the certainty of the diagnosis result.

For example, the outputter may further output second accuracy information indicating a degree of accuracy of the reproduced model.

With this configuration, it is possible to assist a user in determining the certainty of the diagnosis result.

For example, the diagnosis device according to an aspect of the present disclosure may further include an inputter that accepts at least one of: an input of an initial value of a parameter of the reproduction model; an input of a state of the equipment to be diagnosed by the diagnoser; or an input of an allowable time period for the machine learning performed by the model generator.

With this configuration, it is possible to set diagnostic conditions which a user desires.

Furthermore, a diagnosis system according to an aspect of the present disclosure includes the diagnosis device according to each of the aspects described above; and the equipment.

With this configuration, the machine learning is performed using the reproduction data. Accordingly, it is possible to generate a highly accurate diagnosis model, even when the operation data is insufficient. Therefore, the equipment can be diagnosed with high accuracy.

Furthermore, a diagnosis method according to an aspect of the present disclosure includes: obtaining operation data about equipment; identifying a reproduction model using the operation data obtained; generating reproduction data about the equipment based on the reproduction model identified; performing machine learning using the reproduction data generated, to generate a diagnosis model of the equipment; diagnosing the equipment based on the diagnosis model generated; and outputting a diagnosis result.

With this configuration, the machine learning is performed using the reproduction data. Accordingly, it is possible to generate a highly accurate diagnosis model, even when the operation data is insufficient. Therefore, the equipment can be diagnosed with high accuracy.

Further advantages and effects of each aspect of the present disclosure is apparent from the description of the specification and the drawings. Such advantages and/or effects may be provided by each of the several embodiments and features described in the specification and drawings. Here, not all the embodiments, description of the specification, and the drawings necessarily need to be provided to obtain one or more of the same features.

Hereinafter, embodiments according to the present disclosure will be described in detail with reference to the drawings.

It should be noted that each of the embodiments described below represents a comprehensive or a specific example of the present disclosure. The present disclosure is not limited to the following embodiments. Numerical values, shapes, materials, structural components, arrangement positions and connection forms of the structural components, steps, order of steps, and the like described in the following embodiments are examples, and do not intend to restrict the present disclosure. Furthermore, among the structural elements in the following embodiments, structural elements that are not described in independent claims will be described as optional structural elements.

Furthermore, each drawing is a schematic diagram and is not necessarily strictly illustrated. Therefore, the scales and the like in each drawing do not necessarily match, for example. Furthermore, in each drawing, substantially the same configurations are denoted by the same reference numeral, and a duplicate explanation will be omitted or simplified.

### Embodiments

### 1. Configuration

First, a configuration of a diagnosis device and a diagnosis system according to the embodiments is described.

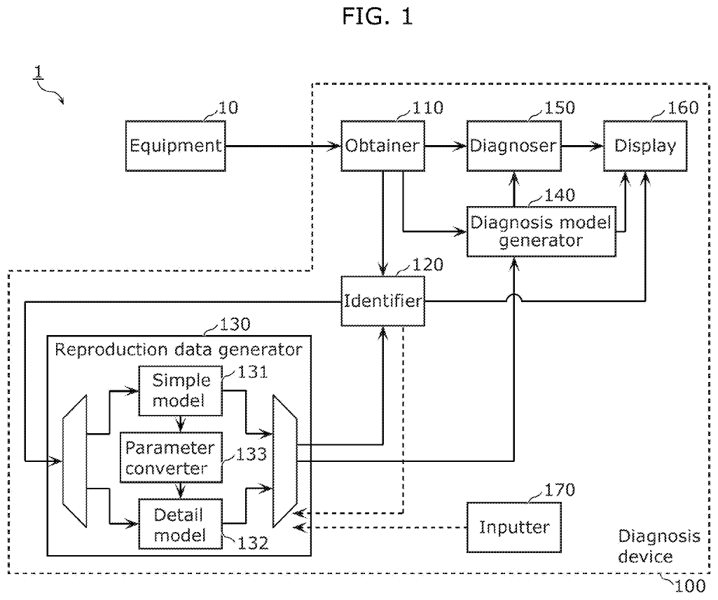

FIG. 1 is a block diagram illustrating an example of a configuration of diagnosis system 1 according to an embodiment of the present disclosure. Diagnosis system 1 shown in FIG. 1 is a system that diagnoses equipment 10. Diagnosis system 1 includes equipment 10 and diagnosis device 100.

Equipment 10 includes facility, equipment, machinery, device, or the like to be monitored by diagnosis device 100. For example, equipment 10 is a manufacturing device that manufactures a product, or an inspection device. Alternatively, equipment 10 may be an air conditioner such as an air conditioning machine, a home appliance such as a refrigerator, a power generator, and the like installed in a standard home or a building such as an office building. For example, equipment 10 may be a rotating machine such as a motor or an electrical generator. Alternatively, equipment 10 may be a mechanism in which these rotating machines are connected to gearboxes, loads, chains, and the like. Furthermore, equipment 10 may be a mechanism such as a robot arm or a moving body, which incorporates these mechanisms.

Equipment 10 is provided with one or more sensors. The sensor detects a physical or electrical value related to a state of equipment 10. For example, the sensor detects current, voltage, or vibration of a driver in equipment 10, or torque of the rotating machine in equipment 10, or the like. The value detected by the sensor is output to diagnosis device 100 as operation data about equipment 10.

Diagnosis device 100 diagnoses equipment 10. “Diagnosis” means determining a state of equipment 10. Specifically, diagnosis device 100 determines whether equipment 10 is in a normal state or not. In the present embodiment, a state that does not correspond to the normal state is regarded as a “failure”. The “failure” includes not only a serious failure such as a stoppage of equipment 10, but also a state in which equipment 10 is operating but performance is lower than the normal state.

Diagnosis device 100 may be a single computer device, or may be a plurality of computer devices connected via a network. Diagnosis device 100 includes, for example, a nonvolatile memory in which a program is stored, a volatile memory that is a temporary storage area for executing the program, an input/output port, a processor that executes the program, and the like. The processor cooperates with a memory and the like to execute processing in each functional processor included in diagnosis device 100.

As shown in FIG. 1, diagnosis device 100 includes obtainer 110, identifier 120, reproduction data generator 130, diagnosis model generator 140, diagnoser 150, display 160, and inputter 170.

Obtainer 110 obtains operation data about equipment 10. Obtainer 110 further performs preprocessing on the obtained operation data. Preprocessing on the operation data includes, for example, filtering, denoising, movement averaging and/or transformation into a frequency spectrum by Fourier transformation or Wavelet transformation.

Obtainer 110 outputs the preprocessed operation data to either identifier 120, diagnosis model generator 140, or diagnoser 150, depending on a processing stage in diagnosis system 1. Specifically, at a stage of generating a diagnosis model, obtainer 110 outputs operation data to identifier 120 and/or diagnosis model generator 140. At the stage of performing a diagnosis based on the diagnosis model, obtainer 110 outputs the operation data to diagnoser 150.

There may be multiple types of the operation data. For example, various data such as current value data or vibration data about a power source of a driver in equipment 10 or torque data about the rotating machine can be used, and these data may be combined.

Identifier 120 identifies a reproduction model using the operation data obtained by obtainer 110. Specifically, identifier 120 identifies the reproduction model by repeatedly updating a parameter of the reproduction model further using reproduction data generated by reproduction data generator 130. More specifically, identifier 120 calculates an error between the operation data obtained by obtainer 110 and the reproduction data generated by reproduction data generator 130. Identifier 120 updates the parameter of the reproduction model so that the calculated error becomes smaller. Identifier 120 updates the parameter until the amount of decrease in error falls below a threshold value.

In the present embodiment, a plurality of reproduction models each having a different total number of parameters are prepared. Identifier 120 first identifies a reproduction model with the least number of parameters among a plurality of reproduction models. For example, identifier 120 repeatedly updates a parameter for one reproduction model. If the amount of decrease in error falls below the threshold value, identifier 120 outputs a control signal to reproduction data generator 130 to use a reproduction model with a larger number of parameters. Thereafter, as necessary, identifier 120 sequentially identifies reproduction models in the order of increasing number of parameters.

Furthermore, identifier 120 outputs, to display 160, a value of the parameter of the identified reproduction model and the calculated error.

Reproduction data generator 130 generates reproduction data about equipment 10 based on the reproduction model identified by identifier 120. Specifically, reproduction data generator 130 generates the reproduction data by simulating an operation state of equipment 10 based on the parameter of the reproduction model updated by identifier 120.

In the present embodiment, reproduction data generator 130 generates reproduction data based on a reproduction model selected from the plurality of reproduction models each having a different total number of parameters and identified by identifier 120. As shown in FIG. 1, reproduction data generator 130 includes simple model 131, detail model 132, and parameter converter 133.

Reproduction data generator 130 generates reproduction data by performing simulation using simple model 131 or detail model 132 in accordance with a control signal input from identifier 120. Simple model 131 is an example of a first reproduction model. Detail model 132 is an example of a second reproduction model. Detail model 132 has more parameters than simple model 131. Specific examples of simple model 131 and detail model 132 will be described later.

Parameter converter 133 generates parameters of detail model 132 by converting a parameter of simple model 131. Parameter converter 133 holds a relational expression between parameters of simple model 131 and detail model 132. Parameter converter 133 receives the identified parameter of simple model 131 and outputs the parameters of detail model 132 based on the relational expression. The relational expression between the parameters is used as an initial value when identifying the parameters of detail model 132. Furthermore, the relational expression between parameters may be used as a constraint condition during identification. In this case, the relational expression between parameters may be held not only in parameter converter 133 but also in identifier 120.

The reproduction model may be switched between three or more reproduction models each having a different total number of parameters. The relational expression between parameters is defined between reproduction models arranged in ascending order of the number of parameters. Alternatively, the relational expression may be defined between each of three or more reproduction models.

It should be noted that the number of parameters is one of indicators representing a “detail level” of the reproduction model. The lower a level of the detail of the reproduction model is, the lower the reproducibility of the reproduction data generated by the reproduction model becomes, and the shorter the time required to identify the reproduction model becomes. The higher the level of detail of a reproduction model is, the longer the time required to identify the reproduction model becomes, and the higher the reproducibility of the reproduction data generated by the reproduction model becomes. In the present embodiment, the reproduction model with a low level of detail is identified in a short period of time and the parameter of the identified reproduction model is converted, thereby shortening the time required to identify a reproduction model with the high level of detail.

Reproduction data generator 130 generates reproduction data about equipment 10 when equipment 10 is operating normally. The normal-time reproduction data is output to identifier 120 and used for updating a parameter.

Furthermore, reproduction data generator 130 generates reproduction data at a time when equipment 10 fails. For example, reproduction data generator 130 reproduces reproduction data for various possible failure times by controlling switching of failure conditions input from inputter 170. The failure-time reproduction data is output to diagnosis model generator 140 and is used as learning data for machine learning. It should be noted that normal-time reproduction data may also be output to diagnosis model generator 140 and used as the learning data for the machine learning.

Diagnosis model generator 140 generates a diagnosis model of equipment 10 by performing the machine learning using the reproduction data generated by reproduction data generator 130. Specifically, diagnosis model generator 140 performs the machine learning using the failure-time reproduction data generated by reproduction data generator 130. Diagnosis model generator 140 outputs the generated diagnosis model to diagnoser 150.

For the machine learning, the normal-time reproduction data generated by reproduction data generator 130 may be used. Furthermore, in addition to the reproduction data generated by reproduction data generator 130, operation data obtained by obtainer 110 may be used for the machine learning. For the machine learning, various known algorithms can be used, such as deep learning using a neural network, support vector machine or random forest, or ensemble learning combining them.

Furthermore, diagnosis model generator 140 evaluates the accuracy of the diagnosis model after learning. Diagnosis model generator 140 outputs, to display 160, an evaluation result of the accuracy of the diagnosis model.

Diagnoser 150 diagnoses equipment 10 based on the diagnosis model generated by diagnosis model generator 140. Specifically, diagnoser 150 determines a state of equipment 10 by inputting, into the diagnosis model, the operation data input from obtainer 110. Diagnoser 150 outputs a diagnosis result to display 160. Contents of the diagnosis include the presence or absence of a failure, a type of the failure, and/or depth of the failure.

Display 160 is an example of an outputter that outputs the diagnosis result made by diagnoser 150. Display 160 may display not only the diagnosis result but also first accuracy information indicating the accuracy of the diagnosis model generated by diagnosis model generator 140. Furthermore, display 160 may display second accuracy information indicating the accuracy of the reproduction model identified by identifier 120. A specific display example will be described later. Display 160 can present various information such as a diagnosis result to a user. Therefore, a user can determine the state of equipment 10 through display 160 and can determine which part of equipment 10 requires maintenance and/or repair.

Display 160 is, for example, a liquid crystal display device or an organic electroluminescence (EL) device. It should be noted that instead of or in addition to display 160, an audio outputter that outputs the diagnosis result and the like in audio may be provided. Alternatively, a communicator may be provided that outputs diagnostic results to the outside through wired or wireless communication.

Inputter 170 accepts input such as information and an instruction from a user. Specifically, inputter 170 accepts at least one of inputs of an initial value of the parameter of a reproduction model, a state of equipment 10 to be diagnosed by diagnoser 150, and an allowable time period for the machine learning by diagnosis model generator 140. For example, inputter 170 accepts input of known parameters of equipment 10 and/or a failure state (failure mode) that is desired to be detected through diagnosis. The known parameters of equipment 10 can be used as the initial value of the parameter of the reproduction model.

Inputter 170 can use, for example, a user interface such as a display with a touch panel. Inputter 170 and display 160 may share the same hardware resource (display).

### 2. Operation

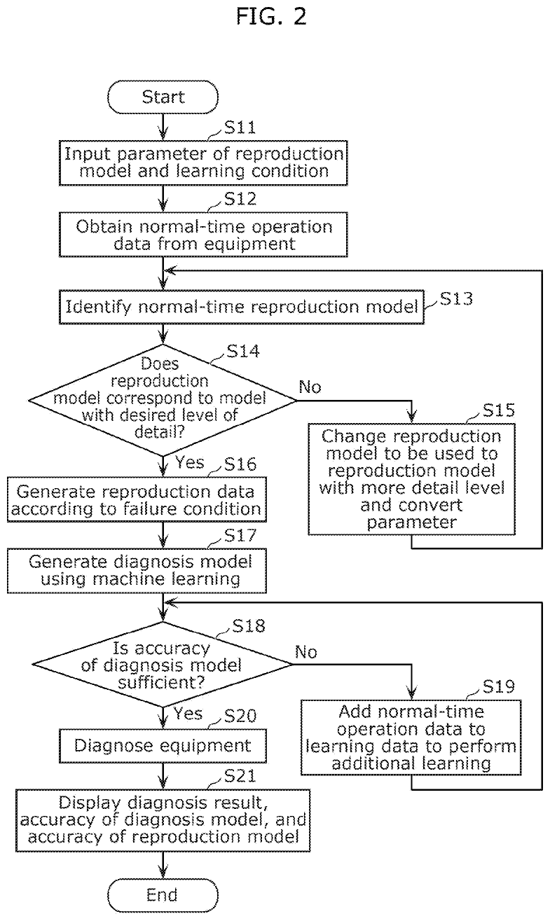

Subsequently, an example of a diagnosis method according to the embodiment of the present disclosure will be described with reference to FIG. 2. FIG. 2 is a flowchart illustrating an example of a diagnosis method according to the embodiment of the present disclosure. The diagnosis method shown in FIG. 2 is executed by diagnosis device 100 shown in FIG. 1.

First, in step S11, inputter 170 accepts inputs such as a parameter of the reproduction model and learning conditions. The learning conditions include, for example, the failure mode that is desired to be detected and the allowable time period for the machine learning. Based on the input information, reproduction data generator 130 or diagnosis model generator 140 determines an extent in the level of detail of the reproduction model to be identified in step S13.

Next, in step S12, obtainer 110 obtains normal-time operation data from equipment 10. It should be noted that step S12 may be performed before step S11, or may be performed concurrently.

In step S13, identifier 120 identifies a reproduction model when equipment is operating normally. Specifically, identifier 120 calculates an error between the operation data at the normal time and the reproduction data generated by performing simulation using simple model 131, and repeats the update of the parameter of simple model 131 so that the calculated error is small, thereby identifying simple model 131.

In step S14, identifier 120 determines whether the identified reproduction model (simple model 131 in this case) is a reproduction model with the desired level of detail, which is determined in step S11. If the identified reproduction model does not have the desired level of detail (No in step S14), the processing moves to step S15. If the identified reproduction model has the desired level of detail (Yes in step S14), the processing moves to step S16.

In step S15, reproduction data generator 130 changes the reproduction model to be used to a model with more detail level (detail model 132 in this case), and converts the identified parameters of simple model 131 to the parameters of detail model 132. Thereafter, the processing returns to step S13, and identifier 120 identifies detail model 132. Steps S13 and S15 are repeated until identification of a reproduction model with the desired level of detail is completed.

After a model with the desired level of detail is identified, reproduction data generator 130 inputs, in step S16, a failure condition to the identified reproduction model and generates reproduction data for various failures corresponding to the failure mode that is desired to be detected. The failure condition is a condition obtained based on the failure mode obtained in step S11.

In step S17, diagnosis model generator 140 performs the machine learning using the various generated failure-time reproduction data and/or normal-time reproduction data as training data to generate a diagnosis model that has learned the characteristics of a sensor value at the time of failure.

In step S18, diagnosis model generator 140 verifies the accuracy of the generated diagnosis model. If the predetermined accuracy requirement is not satisfied (No in step S18), the processing moves to step S19. If the predetermined accuracy requirement is satisfied (Yes in step S18), the processing moves to step S20.

In step S19, diagnosis model generator 140 performs additional learning by adding normal-time operation data to the learning data. The actual operation data is used as the learning data, thereby improving the accuracy of the diagnosis model. Thereafter, the processing returns to step S18, and step S19 is repeated until the diagnosis model satisfies the accuracy requirement. If the diagnosis model does not satisfy the accuracy requirement, the processing may return to step S16, and the reproduction data is additionally generated to further perform additional learning on the generated reproduction data, thereby generating the diagnosis model.

The processing from steps S11 to S19 described above are preparation processing preliminary performed before actual diagnosis. Equipment 10 is diagnosed using the diagnosis model that satisfies the accuracy requirement.

After the accuracy requirement of the diagnosis model is satisfied, diagnoser 150 diagnoses, in step S20, equipment 10 using the diagnosis model that has learned the reproduction data.

In step S21, display 160 displays a diagnosis result, accuracy evaluation of the diagnosis model, and/or accuracy evaluation of the reproduction model.

### 3. Reproduction Model

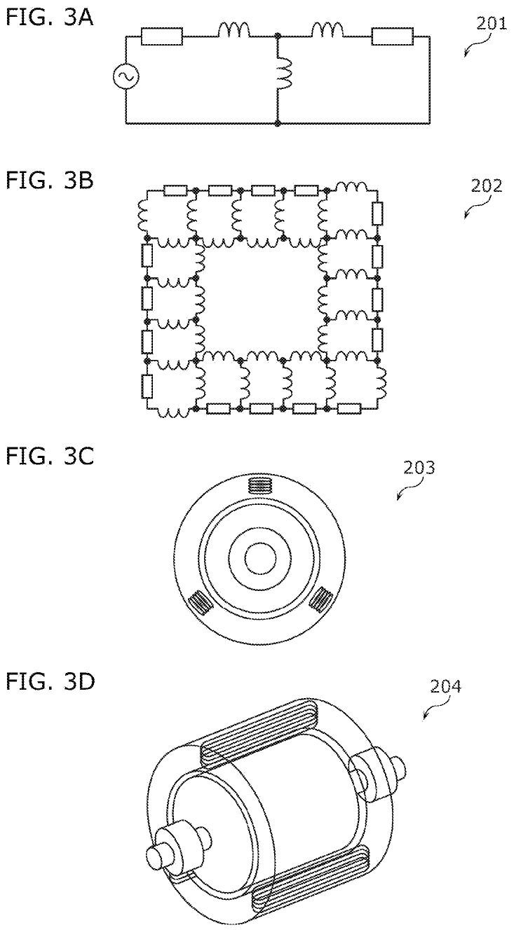

Subsequently, an example of a plurality of reproduction models with mutually different levels of detail according to the embodiment of the present disclosure will be described with reference to FIGS. 3A to 3D. FIGS. 3A to 3D are diagrams illustrating examples of a plurality of reproduction models with mutually different levels of detail according to the embodiment of the present disclosure.

FIGS. 3A to 3D each schematically illustrate a simulation model of equipment 10. Here, a three-phase alternating current (AC) induction motor is taken as an example of equipment 10. It should be noted that equipment 10 is not limited to an induction motor, and may be various types of rotating machines or apparatuses such as an air conditioner or a refrigerator that incorporates the induction motor or the rotating machine.

Reproduction model 201 shown in FIG. 3A is an equivalent circuit model in which an induction motor is modeled using a primary circuit and a secondary circuit. Reproduction model 202 shown in FIG. 3B is a multiple circuit model in which a rotor bar and a ring of the induction motor are regarded as a closed circuit, and a structure in the rotation direction is modeled. Reproduction model 203 shown in FIG. 3C is a two-dimensional FEM model that models not only the structure of the induction motor in the rotation direction but also the structure of the induction motor in the radial direction. Reproduction model 204 shown in FIG. 3D is a three-dimensional FEM model obtained by modeling the structure of the induction motor in the axial direction as well as the rotational direction and the radial direction. Although these four models are exemplified as the simulation models for equipment 10, various other models can be used, each of which has a different total number of parameters and formulas and can be used for expressing relationship between parameters.

Reproduction models 201, 202, 203, and 204 have a larger number of parameters and a higher level of detail in this order. Therefore, the latter one of reproduction models 201, 202, 203, and 204 is more capable of reproducing various failures. On the other hand, the latter reproduction model has a larger number of parameters and takes more time for identification and for generation of one reproduction data (i.e., model analysis).

### 4. Input Screen

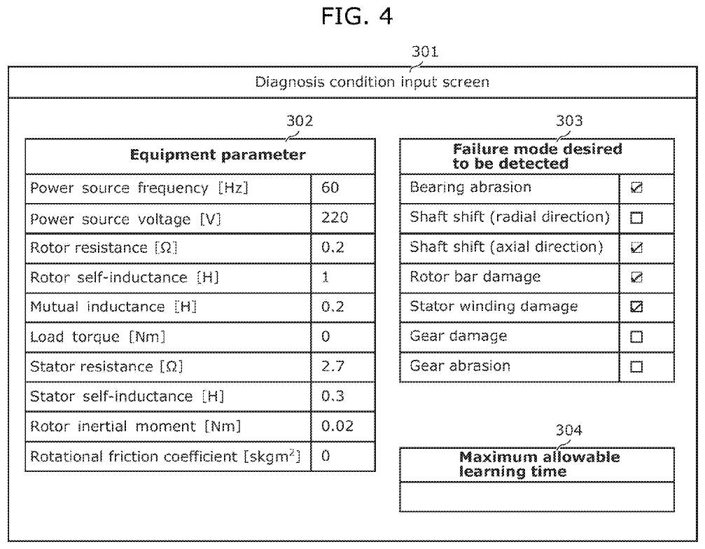

Subsequently, an example of the input screen displayed on display 160 (inputter 170) according to the embodiment of the present disclosure will be described with reference to FIG. 4. FIG. 4 is a diagram illustrating an example of input screen 301 displayed on display 160 according to the embodiment of the present disclosure.

As shown in FIG. 4, input screen 301 includes list 302 of parameters of the induction motor, selection screen 303 for failure modes desired to be detected in the diagnosis by diagnosis system 1, and input screen 304 for a maximum allowable time period for the learning.

Parameter list 302 includes, for example, the parameters of reproduction model 201 with the least number of parameters and a default value for each parameter. Parameters of an induction motor that is commonly used may be adopted as the default values, for example. Alternatively, a value of a parameter identified in another model may be adopted as the default value.

In general, it is not possible to know all the parameters necessary to perform a physical simulation without disassembling or measuring equipment 10. However, some parameters can be known from the specification, nameplate, and/or operation conditions of equipment 10. A user can change the initial value for identification of the reproduction model from the default value to a value close to an actual value by inputting these values as the default values.

Failure mode selection screen 303 includes failure modes that can be detected by diagnosis system 1 and check boxes corresponding to each failure mode. A user can select the failure mode that he or she wants to detect from a plurality of failure modes, by checking the checkbox on selection screen 303.

Maximum allowable learning time input screen 304 accepts the maximum learning time allowable to a user. Input screen 304 includes a text box in which a user can input a numerical value.

Reproduction data generator 130 or diagnosis model generator 140 determines the reproduction model that can reproduce the failure in the most detail within the maximum learning time allowable to a user as a reproduction model to be identified in step S13, from correspondence among the failure mode checked on selection screen 303, the failure mode that can be reproduced by each of reproduction models 201 to 204 in the induction motor, and the time required for a single analysis and/or the maximum allowable learning time.

For example, if the failure mode that a user wants to detect can be sufficiently reproduced with reproduction model 201 shown in FIG. 3A, there is no need to identify reproduction models 202 to 204 having a large number of parameters. Accordingly, reproduction model 201 is determined as the reproduction model to be identified.

Alternatively, if the failure mode that the user wants to detect can be reproduced with reproduction model 203 shown in FIG. 3C, and can also be reproduced with higher accuracy with reproduction model 204 shown in FIG. 3D, a reproduction model to be identified is determined based on the allowable time period input on input screen 304. For example, though reproduction model 203 may perform the machine learning within the allowable time period, reproduction model 204 may not complete the machine learning within the allowable time period. In such a case, reproduction model 203 is determined as the reproduction model to be identified. If the machine learning can be performed on both reproduction models 203 and 204 within the allowable time period, reproduction model 204 with high accuracy is determined as the reproduction model to be identified.

It should be noted that input screen 301 does not need to include at least one of parameter list 302, failure mode selection screen 303, and maximum allowable learning time input screen 304. Although FIG. 4 shows an example in which parameter list 302, failure mode selection screen 303, and maximum allowable learning time input screen 304 are included in a single screen, the present disclosure is not limited to the above case. Parameter list 302, failure mode selection screen 303, and maximum allowable learning time input screen 304 may each be separately included in a single screen, and screens may be switchable.

### 5. Identification of Reproduction Model

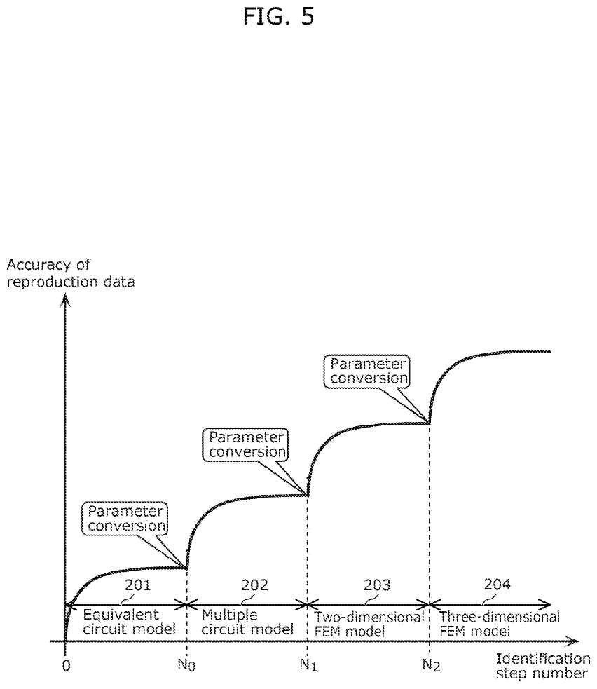

Subsequently, an example of identification of the reproduction model according to the embodiment of the present disclosure will be described with reference to FIG. 5.

FIG. 5 is a graph showing relationship between accuracy of the generated reproduction data and the number of identification steps, according to the embodiment of the present disclosure. The number of identification steps represented by the horizontal axis in FIG. 5 is the number of updates of parameters. The accuracy of the reproduction data represented by the vertical axis in FIG. 5 represents a level of the reproducibility of the reproduction data, and represents the smallness of an error between the reproduction data and the actual operation data. In other words, the smaller the error is, the higher the accuracy of the reproduction data becomes.

Identifier 120 starts identification from reproduction model 201 (equivalent circuit model) that is the simplest model. Identifier 120 compares the normal-time reproduction data generated by reproduction data generator 130 performing simulation using reproduction model 201 and the normal-time operation data obtained by obtainer 110, and sequentially updates the parameter of the equivalent circuit model so that the error becomes small. A single update of the parameter corresponds to a single identification step. Reproduction model 201 has a small number of parameters and a short analysis time. Therefore, it is easy to converge to accurate parameters. On the other hand, since the degree of representation of the reproduction model is low, it is not possible to reduce the error beyond a certain level even if the identification is continued. In other words, the accuracy of the reproduction data cannot be increased beyond a certain level and becomes saturated.

As shown in FIG. 5, when the identification step number No is achieved, at which an error cannot be reduced beyond a certain level even if the parameter is updated, a model to be used is changed to reproduction model 202 (multiple circuit model). At this time, an initial value of the parameter of the multiple circuit model is determined using the relational expression shown in expression (1) below. Accordingly, the identification can be started from highly accurate initial value and can converge to the accurate parameter in a short period of time. Furthermore, it is possible to converge to the accurate parameter by using expression (1) as a parameter constraint.

Expression (1) below is an example of the expression showing the relationship between the parameter of reproduction model 201 that is the equivalent circuit model shown in FIG. 3A, and reproduction model 202 that is the multiple circuit model shown in FIG. 3B. Expression (1) is held in parameter converter 133.

$$\begin{matrix}[ Math . 1 ] & \\ {L}_{S}^{( A )} = {μ}_{0} {l}^{( B )} {R}^{( B )} \frac{1}{{g}^{( B )}} \frac{{W}^{{( B )}^{2}}}{4} π & ( 1 )\end{matrix}$$

In expression (1), Lₛ^{(A)} on the left side represents a self-inductance of a stator winding wire circuit of the equivalent circuit model. I^{(B)}, R^{(B)}, g^{(B)}, and W^{(B)} on the right side are the rotor length, rotor radius, an airgap distance between the rotor and the stator, and the total number of series coil turns per layer and per pole in the multiple circuit model, respectively. μ₀ is a magnetic permeability of vacuum.

The relational expression expressed by expression (1) is an expression analytically determined from a physical expression. Here, the self-inductance of the equivalent circuit model is taken as an example, but other relationships such as relationship between a resistance value of the stator in the equivalent circuit model and the number and resistance value of the rotor bar in the multiple circuit model are also assumed. A plurality of these relational expressions may be used simultaneously.

Parameter identification and parameter conversion are performed step by step between the multiple circuit model and the two-dimensional FEM model, and between the two-dimensional FEM model and the three-dimensional FEM model, respectively, until a reproduction model with the desired level of detail determined in step S11 is identified. As a result, even for a model such as a three-dimensional FEM model that takes a long time for a single analysis and has a large number of parameters, an accurate parameter can be identified from the operation data in a short period of time.

### 6. Training Data and Learning

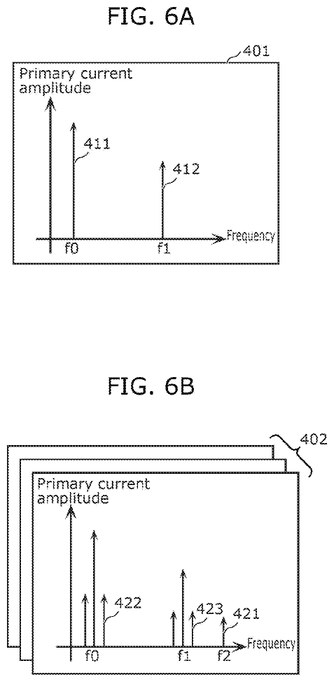

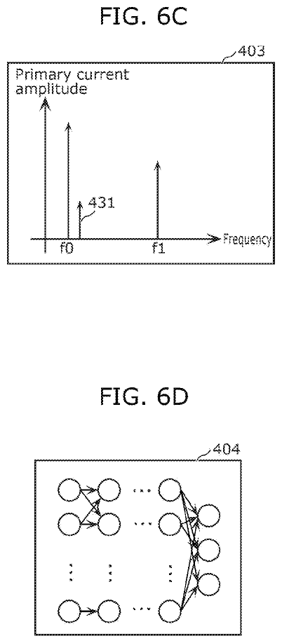

Subsequently, an example of the training data and the learning according to the embodiment of the present disclosure will be described with reference to FIGS. 6A to 6D. FIGS. 6A to 6C are diagrams each illustrating an example of the training data to be learned by diagnosis model generator 140 according to the embodiment of the present disclosure. FIG. 6D is a diagram illustrating an example of the machine learning performed by diagnosis model generator 140 according to the embodiment of the present disclosure.

The training data shown in FIGS. 6A to 6C all represent relationship between the amplitude and the frequency of a primary current of the induction motor. Specifically, FIG. 6A shows normal-time reproduction data 401 generated by reproduction data generator 130 using the reproduction model. FIG. 6B shows a plurality of items of failure-time reproduction data 402 generated by reproduction data generator 130 using the reproduction model. FIG. 6C shows normal-time operation data 403 obtained by obtainer 110 from equipment 10. In the following description, the data to be learned will be described based on primary current data measured by a current sensor, but the same applies to various data that can be measured from equipment 10 and includes mechanical vibration, torque, and angular velocity.

As shown in normal-time reproduction data 401 in FIG. 6A, characteristics of the induction motor appear as frequency peaks of the primary current. Specifically, in reproduction data 401, not only power supply frequency 411 but also frequency peak 412 reflecting a structure of the induction motor appears. The more detail the reproduction model is, the more frequency peaks can be reproduced.

Reproduction data 402 at the time of failure in FIG. 6B includes frequency peaks 421, 422, and 423 at the time of reproduced failure times, by switching failure conditions of the reproduction model. Specifically, frequency peak 421 represents fundamental frequency component f2 resulting from eccentricity of the rotating shaft. Frequency peaks 422 and 423 are frequency components generated by superimposing each of frequencies f0 and f1 resulting from the basic characteristics of the motor and frequency component f2. A wide variety of failures can be reproduced, and at the same time, the characteristics of the same failure condition can be reproduced in more detail, by using a detailed reproduction model.

The failure conditions include, for example, qualitative variables such as a type of failure. Alternatively, the failure conditions may include quantitative variables such as depth of failure. Depending on these failure conditions, a teacher label is assigned to the reproduction data at the time of failure. Furthermore, the diagnosis model is determined to be a classification model or a regression model depending on a label of the training data.

Operation data 403 shown in FIG. 6C includes frequency peak 431 of normal-time operation data that could not be reproduced by the reproduction model. Various factors that were not assumed during the simulation, such as electromagnetic noise, environmental vibration, and phase imbalance of the power supply, are assumed to be factors causing frequency peak 431. Such frequency peak 431 may occur at the same frequency as frequency peaks 421 to 423 at the time of failure. In this case, it may cause diagnosis system 1 to erroneously detect a failure.

FIG. 6D shows an example of neural network 404 that identifies failure modes from input data. Neural network 404 is an example of the diagnosis model generated by diagnosis model generator 140, and is generated by learning the characteristics of each failure condition after using reproduction data 401 and 402 as the training data. With this configuration, failures can be detected from the operation data without using, as the training data, operation data at the time of failure, which tends to be insufficient.

Furthermore, diagnosis model generator 140 performs additional learning using normal-time operation data 403 as normal-time training data. This can prevent diagnosis system 1 from erroneously detecting a state of equipment 10 operating normally as a failure. For the additional learning, in the case of neural network 404, for example, various methods such as fine tuning or transfer learning can be used.

Classification accuracy of neural network 404 (diagnosis model) is evaluated based on whether each failure can be detected correctly and whether data at the normal time is not mistakenly detected as a failure. When the normal-time reproduction data and the operation data are indistinguishable, it may be evaluated as high accuracy. If neural network 404 is a regression model, the error and/or error rate between a true value and a predicted value may be evaluated. For the accuracy target, a value recorded in advance inside diagnosis system 1 may be used, or a value input by a user may be used. If the predetermined accuracy target is not reached, learning conditions such as hyperparameters may be changed and the learning may be performed again. Furthermore, the accuracy may not improve even if the learning conditions are changed. In such a case, the predetermined accuracy target may be changed.

### 7. Display Example of Diagnosis Result

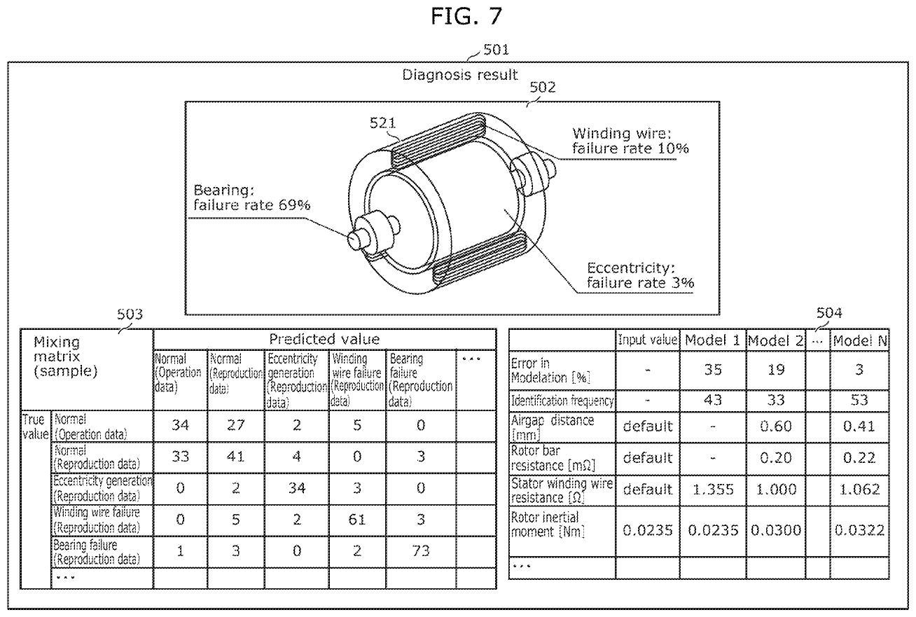

Subsequently, a display example of diagnosis results according to the embodiment of the present disclosure will be described with reference to FIG. 7. FIG. 7 is a diagram illustrating an example of a diagnosis result displayed on display 160 according to the embodiment of the present disclosure.

Display screen 501 shown in FIG. 7 includes diagnosis result 502 indicating a diagnosis of failure, mixing matrix 503 indicating the accuracy of the diagnosis model used for the diagnosis, and model accuracy information 504 for the reproduction model used to generate the reproduction data at the time of a failure. An example of errors and parameters after the identification is shown.

Diagnosis result 502 includes schematic diagram 521 of a visualized reproduction model. Schematic diagram 521 is an image illustrating a reproduction model used for simulation of the reproduction data at the time of failure. Failure rates respectively corresponding to failure parts in schematic diagram 521 are displayed. The failure parts and the failure rates are displayed in a correspondence manner, so that a user can more intuitively understand the state of equipment 10.

Mixing matrix 503 is an example of the first accuracy information indicating the accuracy of the diagnosis model used for diagnosis. Mixing matrix 503 represents relationship between an input value (true value) to the diagnosis model and an output value (predicted value) of the diagnosis model. As the input value, not only the operation data obtained by obtainer 110 but also the reproduction data of each failure mode, which is generated by reproduction data generator 130, are shown. The larger the number of predicted values that are the same as the true value, i.e., the higher the numerical value on a downward diagonal line of mixing matrix 503 is, the higher the accuracy of the diagnosis model is. Furthermore, mixing matrix 503 in FIG. 7 also includes the results of discrimination between reproduction data during the normal time and operation data during the normal time. Accordingly, a user can be assured that the normal-time operation data will not be mistakenly identified as a failure.

It should be noted that the first accuracy information indicating the accuracy of the diagnosis model is not limited to mixing matrix 503. A graph such as a receiver operating characteristic curve (ROC curve) or a precision-recall curve (PR curve) may be used, for example. When a regression model is used as the diagnosis model, correlation coefficients and/or mean square errors regarding the amount of failures in each failure mode may be displayed as the first accuracy information.

Model accuracy information 504 includes a list of errors and parameters, after the identification, of the reproduction model used for generating the failure-time reproduction data. Specifically, “Model 1” to “Model N” shown in FIG. 7 correspond to reproduction models 201 to 204, for example. Specific values of errors and parameters after the identification are displayed, thereby assuring the accuracy of the reproduction data to the user.

It should be noted that display screen 501 does not need to include at least one of diagnosis result 502, mixing matrix 503, and model accuracy information 504. Although FIG. 7 shows an example in which diagnosis result 502, mixing matrix 503, and model accuracy information 504 are included in one screen, the present disclosure is not limited to this style. Diagnosis result 502, mixing matrix 503, and model accuracy information 504 may each be included in one screen, and the screens may be switchable.

### 8. Summary

As described above, according to an aspect of the present disclosure, reproduction models with a plurality of levels of detail can be identified step by step with using relational expressions between parameters. Accordingly, it is possible to generate highly accurate reproduction data at the time of a failure. It is also possible to generate, by the machine learning, a diagnosis model that detects the failure state of equipment 10 even if the operation data at the time of failure is insufficient. Furthermore, the operation data during the normal operation is additionally learned, thereby preventing erroneous detection by diagnosis system 1 in an environment with noise. In addition, diagnosis result 502 is displayed in correspondence with schematic diagram 521 of the reproduction model shown on the screen, so that a user can intuitively understand the state of the equipment.

### Other Embodiments

Although various embodiments have been described above with reference to the drawings, the present disclosure is not limited to such examples. It is apparent that those skilled in the art can achieve various variations or modifications within the scope of claims, and it is understood that such variations or modifications also naturally fall within the technical scope of the present disclosure. In addition, each of the structural components in the above embodiments may be randomly combined without departing from the spirit of the present disclosure.

Although the present disclosure has been described with an example embodied using hardware in each of the embodiments described above, for example, the present disclosure can also be embodied by software in cooperation with hardware.

Furthermore, communication methods between devices described in the above embodiments are not particularly limited. When wireless communication is performed between devices, a wireless communication method (communication standard) is, for example, short-range wireless communication such as ZigBee (registered trademark), Bluetooth (registered trademark), or a wireless local area network (LAN). Alternatively, the wireless communication method (communication standard) may be communication via a wide area communication network such as the Internet. Furthermore, wired communication may be performed between the devices instead of wireless communication. Specifically, the wired communication is power line communication (PLC) or communication using a wired LAN.

Furthermore, in the above embodiments, processing performed by a specific processor may be performed by another processor. In addition, the order of a plurality of processes may be changed, or a plurality of processes may be executed in parallel. Furthermore, distribution of structural components included in the diagnosis system to a plurality of devices is one example. For example, components included in a certain device may be included in another device. The diagnosis system may also be embodied as a single device.

For example, the processing described in the above embodiments may be performed by centralized processing using a single device (system), or may be performed by distributed processing using multiple devices. Furthermore, the number of processors that execute the above program may be in the singular or plural. In other words, the centralized processing may be performed, or distributed processing may be performed.

Furthermore, in the above embodiments, all or part of the structural components such as a controller may be configured with dedicated hardware, or may also be embodied by executing a software program suitable for each structural component. Each structural component may be embodied by a program executor such as a central processing unit (CPU) or a processor reading and executing a software program recorded on a recording medium such as a hard disk drive (HDD) or a semiconductor memory.

Furthermore, a structural component such as a controller may be configured with one or more electronic circuits. Each of the one or more electronic circuits may be a general-purpose circuit or a dedicated circuit.

Furthermore, each functional block used in the description of the above embodiment is typically embodied as a large scale integration (LSI) chip that is an integrated circuit. The integrated circuit may control each of the functional blocks in the disclosure of the above embodiments and may include an input and an output. These may be individually integrated into a single chip, or may be integrated into a single chip including some or all of them. Although it is referred to as the LSI chip in the disclosure, it may also be called an integrated circuit (IC), a system LSI chip, a super LSI chip, or an ultra LSI chip depending on the degree of integration.

Furthermore, each functional block is not limited to being embodied using the LSI chip, and may be embodied using a dedicated circuit or a general-purpose processor. Alternatively, each functional block may use a field programmable gate array (FPGA) that can be programmed after the LSI chip is manufactured, or a reconfigurable processor that can reconfigure the connection or setting of circuit cells inside the LSI chip.

Furthermore, if an integrated circuit technology that replaces the LSI emerges owing to advancements in semiconductor technology or other derivative technologies, it is natural that the functional blocks may be integrated using such technology. Possible applications include biotechnology and photonic integrated circuits.

In addition, general or specific aspects of the present disclosure may be embodied by a system, an apparatus, a method, an integrated circuit, or a computer program. Alternatively, the general or specific aspects of the present disclosure may be embodied by a computer-readable non-transitory recording medium such as an optical disk, an HDD, or a semiconductor memory, in which the computer program is stored. Furthermore, the aspects of the present disclosure may be embodied by any combination of the system, the apparatus, the method, the integrated circuit, the computer program, and the recording medium.

Various changes, substitutions, additions, omissions, and the like can be made to each of the embodiments described above within the scope of claims or their equivalents.

### INDUSTRIAL APPLICABILITY

The present disclosure can be used in a diagnosis device and a diagnosis method for equipment, and is useful, for example, in a diagnosis system for diagnosing failures and malfunctions in the equipment.

1. A diagnosis device comprising:
an obtainer that obtains operation data about equipment;
an identifier that identifies a reproduction model using the operation data obtained by the obtainer;
a data generator that generates reproduction data about the equipment based on the reproduction model identified by the identifier;
a model generator that performs machine learning using the reproduction data generated by the data generator, to generate a diagnosis model of the equipment;
a diagnoser that diagnoses the equipment based on the diagnosis model generated by the model generator; and
an outputter that outputs a diagnosis result provided by the diagnoser.

2. The diagnosis device according to claim 1, wherein
the data generator generates the reproduction data based on the reproduction model that is selected from a plurality of reproduction models each having a different total number of parameters and is identified by the identifier.

3. The diagnosis device according to claim 2, wherein
the plurality of reproduction models include a first reproduction model and a second reproduction model having a total number of parameters larger than a total number of parameters of the first reproduction model, and
the data generator includes a parameter converter that converts a parameter of the first reproduction model identified by the identifier, to generate a parameter of the second reproduction model.

4. The diagnosis device according to claim 1, wherein
the data generator generates normal-time reproduction data about the equipment, and
the identifier repeatedly updates a parameter of the reproduction model using the normal-time reproduction data generated by the data generator, to identify the reproduction model.

5. The diagnosis device according to claim 1, wherein
the data generator generates failure-time reproduction data about the equipment, and
the model generator performs the machine learning using the failure-time reproduction data generated by the data generator.

6. The diagnosis device according to claim 5, wherein
the data generator further generates normal-time reproduction data about the equipment, and
the model generator performs the machine learning further using the normal-time reproduction data generated by the data generator.

7. The diagnosis device according to claim 1, wherein
the model generator performs the machine learning further using the operation data obtained by the obtainer.

8. The diagnosis device according to claim 1, wherein
the outputter includes a display that displays the diagnosis result.

9. The diagnosis device according to claim 1, wherein
the outputter further outputs first accuracy information that indicates a degree of accuracy of the diagnosis model.

10. The diagnosis device according to claim 1, wherein
the outputter further outputs second accuracy information indicating a degree of accuracy of the reproduced model.

11. The diagnosis device according to claim 1 further comprising:
an inputter that accepts at least one of: an input of an initial value of a parameter of the reproduction model; an input of a state of the equipment to be diagnosed by the diagnoser; or an input of an allowable time period for the machine learning performed by the model generator.

12. A diagnosis system comprising:
the diagnosis device according to claim 1; and
the equipment.

13. A diagnosis method comprising:
obtaining operation data about equipment;
identifying a reproduction model using the operation data obtained;
generating reproduction data about the equipment based on the reproduction model identified;
performing machine learning using the reproduction data generated, to generate a diagnosis model of the equipment;
diagnosing the equipment based on the diagnosis model generated; and
outputting a diagnosis result.
